(19) United States
(12) Patent Application Publication
(10) Pub. No.: US 2011/0181593 A1
(43) Pub. Date: Jul. 28, 2011

(54) IMAGE PROCESSING APPARATUS, 3D DISPLAY APPARATUS, AND IMAGE PROCESSING METHOD

(76) Inventors: Ryusuke HIRAI, Tokyo (JP); Takeshi MITA, Yokohama-shi (JP); Nao MISHIMA, Inagi-shi (JP); Kenichi SHIMOYAMA, Tokyo (JP); Masahiro BABA, Yokohama-shi (JP)

(21) Appl. No.: 13/015,198

(22) Filed: Jan. 27, 2011

(30) Foreign Application Priority Data
Jan. 28, 2010 (JP) 2010-016227
Jan. 25, 2011 (JP) 2011-012646

(51) Int. Cl. G06K 9/46; G06T 15/20

(52) U.S. Cl. 345/427; 382/276; 382/190

(57) ABSTRACT

According to an embodiment, an image processing apparatus includes an acquisition unit, a setting unit, a transform unit and a generation unit. The acquisition unit is configured to acquire a parallax value of each pixel of a plurality of images having a parallax. The setting unit is configured to set at least one reference range within a range of the parallax value. The transform unit is configured to apply transform to the parallax value of each pixel so as not to change a parallax value belonging to the reference range but to change a parallax value that does not belong to the reference range without changing a magnitude relationship between the parallax values of the pixels. The generation unit is configured to generate a parallax image from the image based on the parallax values after applying the transform.

### CROSS-REFERENCE TO RELATED APPLICATIONS

This application is based upon and claims the benefit of priority from Japanese Patent Applications No. 2010-016227, filed Jan. 28, 2010; and No. 2011-012646, filed Jan. 25, 2011; the entire contents of both of which are incorporated herein by reference.

### FIELD

Embodiments described herein relate generally to an image processing apparatus, a 3D display apparatus, and an image processing method capable of adjusting the parallax value between images.

### BACKGROUND

A 3D image is created using various methods by, for example, (1) causing a 3D video camera formed by arranging a plurality of image capturing devices to capture images of a plurality of viewpoints or (2) generating images of a plurality of viewpoints based on the depth estimated from one or more images. In many cases, already created images of a plurality of viewpoints are input to an apparatus for displaying a 3D image. Hence, regarding the displayed 3D image, the magnitude of parallax (to be referred to as a parallax value hereinafter) of each pixel between the images of different viewpoints has a predetermined value fixed upon creation in most cases.

On the other hand, a 3D image is sometimes reproduced on a display screen whose size is different from that assumed at the time of creation. At this time, the user may have a sense of incongruity in the reproduced 3D image. Additionally, for example, the user may have a requirement to reduce fatigue by adjusting the parallax value in accordance with his/her own eyestrain state. Hence, the technique of adjusting the parallax value as needed is important.

As a method of adjusting the parallax value, a technique is disclosed which derives an offset amount from the display screen size, the distance between the user and the display screen, and the like and translates the image for one eye in the direction of parallax generation by the offset amount (for example, Japanese Patent No. 3978392). That is, this technique can increase or decrease the depth for the user by translating the entire image by a predetermined amount.

For this reason, if subtitles exist at part of the image, a phenomenon such as character size change occur, resulting in a sense of incongruity for the user.

### BRIEF DESCRIPTION OF THE DRAWINGS

FIG. 1 is a block diagram showing a 3D display apparatus according to the first embodiment;

FIG. 2 is a view for explaining the relationship between the depth and the parallax value;

FIG. 3 is a view for explaining the relationship between the depth and the parallax value;

FIG. 4 is a view for explaining pixel positions;

FIG. 5A is a view showing the relationship between an input image and the depth value;

FIG. 5B is a view showing the relationship between an input image and the depth value;

FIG. 6 is a view showing an example of a parallax value transform function;

FIG. 7 is a view for explaining a parallax image generation method;

FIG. 8 is a block diagram showing a 3D display apparatus according to the second embodiment; and

FIG. 9 is a view for explaining the relationship between the depth and the parallax value.

### DETAILED DESCRIPTION

In general, according to an embodiment, an image processing apparatus includes an acquisition unit, a setting unit, a transform unit and a generation unit. The acquisition unit is configured to acquire a parallax value of each pixel of a plurality of images having a parallax. The setting unit is configured to set at least one reference range within a range of the parallax value. The transform unit is configured to apply transform to the parallax value of each pixel so as not to change a parallax value belonging to the reference range but to change a parallax value that does not belong to the reference range without changing a magnitude relationship between the parallax values of the pixels. The generation unit is configured to generate a parallax image from the image based on the parallax values after applying the transform. The embodiments will now be described.

Note that the same reference numerals denote components or processes for performing the same operations, and a repetitive description thereof will be omitted.

### First Embodiment

A 3D display apparatus of this embodiment can adopt any one of various methods such as a glasses method or naked-eye method capable of 3D display. In the following embodiment, a two-view display which displays a 3D image by a time division method using glasses will be described. Examples of the time division method are a liquid crystal shutter glasses method, polarizing filter glasses method, and RGB waveband separating filter glasses method. In this embodiment, a time division method using glasses of the liquid crystal shutter glasses method will be described. The time division method may be either field sequential or frame sequential. In this embodiment, a frame sequential time division method will be described.

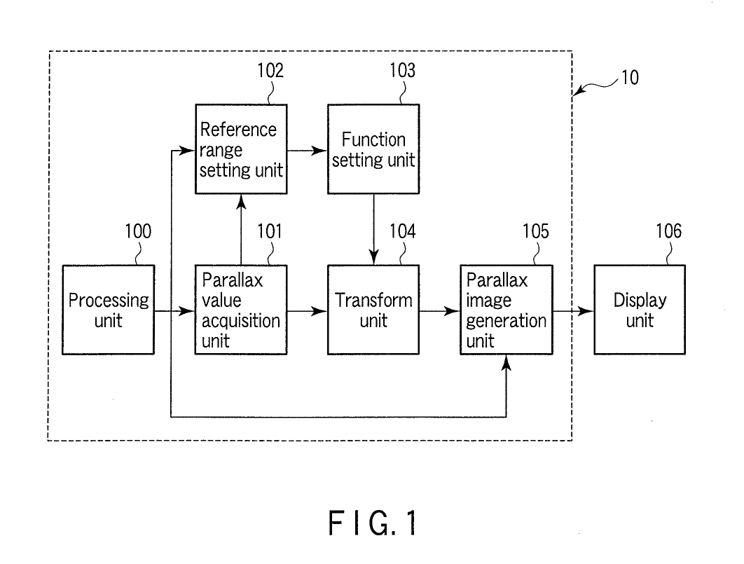

FIG. 1 is a block diagram showing the 3D display apparatus according to the embodiment. The 3D display apparatus of this embodiment comprises an image processing apparatus 10 which adjusts the parallax value of an input image, and a display unit 106 which displays a 3D image that has undergone parallax value adjustment by the image processing apparatus 10. The display unit 106 alternately displays a left-eye image and a right-eye image, which have a parallax. Dedicated glasses separate the display image into the left-eye image and the right-eye image. The images with a parallax are separately displayed for the user's left and right eyes so as to implement 3D vision using a binocular parallax. The components of the 3D display apparatus of this embodiment will be described later.

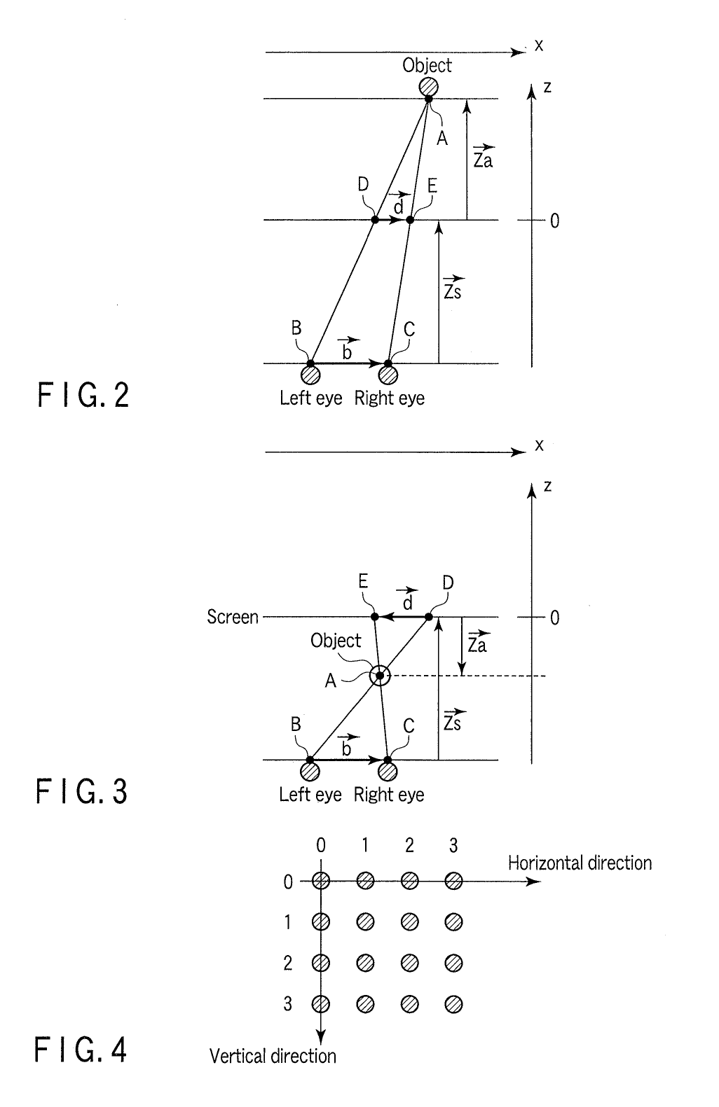

The relationship between the parallax value and the depth will be described first with reference to FIGS. 2 and 3. The axis of a depth value Za(=|Za→|) is set in a direction (the depth direction of the display screen) perpendicular to the display screen. Hence, the depth value Za is represented by a one-dimensional scalar. The parallax is typically set in the horizontal direction. However, the parallax may be set in another direction (for example, vertical direction) depending on a factor such as a viewing environment. For example, when the user is lying down, the line connecting his/her eyes (to be referred to as an eyeline hereinafter) is parallel not to the horizontal direction but to the vertical or oblique direction. Hence, the parallax is supposedly shifted on an axis parallel to the eyeline. Since the parallax can be set in an arbitrary direction, as described above, the parallax will be expressed as a vector in the following description. In the following description, the parallax is assumed to be set in the horizontal direction (x-axis direction).

FIG. 2 schematically shows the relationship between the depth value and the parallax value. FIG. 2 is a bird's eye view showing the positional relationship of elements when the user sees the display screen of the display unit 106. The depth value is set on the z-axis, and z=0 corresponds to the position of the display screen. The x-axis is parallel to the display screen (line DE). In this example, the x-axis is parallel to the eyeline of the user (line segment BC), too. A point B indicates the position of the left eye of the user. A point C indicates the position of the right eye of the user. The length of the line segment BC (that is, the distance between the eyes of the user) is represented by b(=|b→|). Zs (|Zs→|) is the distance from the user to the display screen. Za is the depth value of the object.

A point A represents a virtual position where the user perceives the object. The point A has the depth value Za from the display screen. A point D indicates the position of the object actually displayed on the display screen for the left-eye image. A point E indicates the position of the object actually displayed on the display screen for the right-eye image. That is, the length of the line segment DE represents the parallax value. The parallax vector is a vector from the point D to the point E. In the following description, the parallax vector is expressed as “d→”. The parallax value is the magnitude (absolute value) |d→| of the parallax vector d-*.

FIG. 3 schematically shows the relationship between the depth value and the parallax value when the virtual position of the object is set on the near side of the display screen. The symbols in FIG. 3 are the same as in FIG. 2, and a description thereof will not be repeated. Comparing FIG. 3 with FIG. 2, the positional relationship of the points D and E on the x-axis is reversed (that is, the direction of parallax vector d→ is reversed).

In FIG. 2, considering that the triangles ABC and ADE are similar, (|Za→+Zs→|):|Za→|=b:|d→| holds. That is,

$$\vert \vec{d} \vert = b \frac{\vert {\vec{Z}}_{a} \vert}{\vert {\vec{Z}}_{a} + {\vec{Z}}_{s} \vert} \qquad ( 1 )$$

holds concerning the parallax value |d→|.

In addition, considering the definitions of the x- and z-axes in FIG. 2,

$$\vec{d} = ( b \frac{{\vec{Z}}_{a}}{\vert {\vec{Z}}_{a} + {\vec{Z}}_{s} \vert} , 0 ) \qquad ( 2 )$$

holds concerning the parallax vector d→.

More specifically, the depth value Za and the parallax vector d→ can be transformed to each other. In the following explanation, a description about the parallax vector can be interpreted as a description about the depth value as needed, and vice versa.

In FIG. 4, each pixel position of an image is represented by a circle, and the horizontal and vertical axes are illustrated. Each pixel position is defined by coordinates represented by an integer position on the horizontal axis and an integer position on the vertical axis. In the following description, all vectors other than the parallax vector have the starting point at (0, 0), unless it is specifically stated otherwise.

FIG. 1 will be described in detail. Referring to FIG. 1, the image processing apparatus 10 comprises a processing unit 100, parallax value acquisition unit 101, reference range setting unit 102, function setting unit 103, transform unit 104, and parallax image generation unit 105.

The processing unit 100 receives a first image (for example, a 3D image signal for the left eye) and a second image (for example, a 3D image signal for the right eye) of a viewpoint different from that of the first input image from outside. Various methods are usable to supply the input images. For example, a plurality of images with a parallax may be acquired from a tuner or by reading information stored on an optical disc. Alternatively, one 2D image may be supplied from outside to the processing unit 100. In this case, the processing unit 100 estimates the depth value from the one 2D image, thereby generating a plurality of images with a parallax.

The parallax value acquisition unit 101 acquires the parallax value of each pixel between the plurality of images with the parallax. For example, the parallax value acquisition unit 101 estimates the parallax value of each pixel, and inputs the estimated parallax value to the reference range setting unit 102 and the transform unit 104. Various methods are usable to acquire the parallax value. For example, the stereo matching method is applicable to calculate the parallax value of each pixel between the first input image and the second input image. Alternatively, if the processing unit 100 generates the plurality of images with the parallax by estimating the depth value for one 2D image, the parallax value can be obtained from the depth value estimated upon generating the plurality of images.

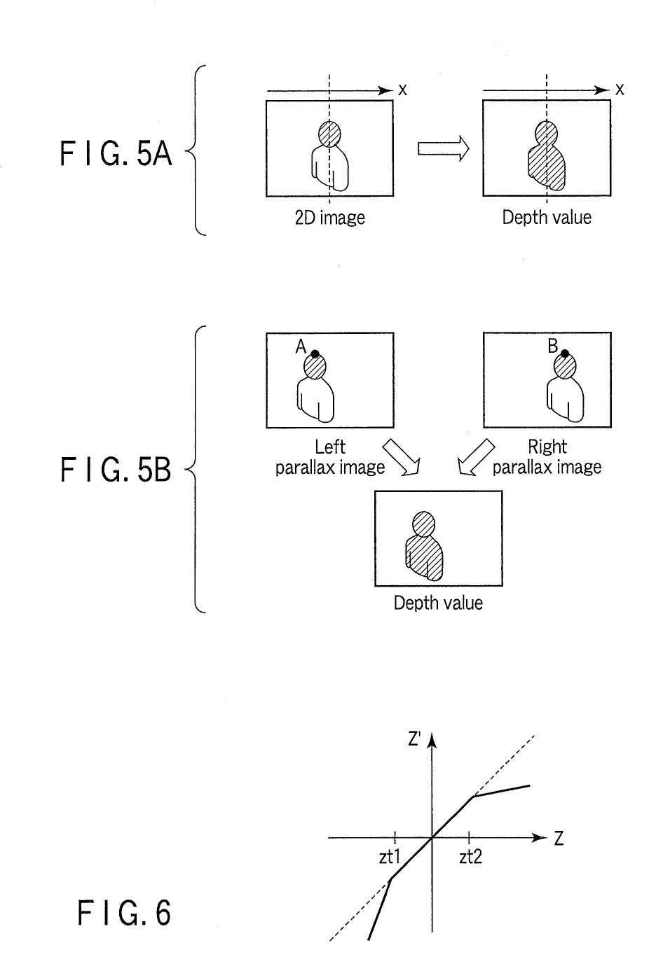

FIGS. 5A and 5B show the relationship between the input image and the depth value. In FIG. 5A, as the depth values of the pixels of the 2D image on the left side of the drawing become smaller, corresponding pixels are illustrated dark on the right side of the drawing. The position vector of an arbitrary pixel in the image can be expressed as i→. The depth value of the pixel of the position vector i→ can be represented by z(i), and the parallax vector can be represented by d(i)→. Let ia→ be the position vector of an arbitrary point A of the left parallax image (that is, left-eye image) in FIG. 5B. A point B in the right parallax image (that is, right-eye image) corresponding the point A can be derived by, for example, block matching. Let ib→ be the position vector of the corresponding point B. In this case, parallax vector d(ia)→ equals (ib→−ia→). Similarly, the depth value of each pixel in the left parallax image can be obtained. Note that in this embodiment, each pixel in the left parallax image is defined as the starting point of the parallax vector. However, each pixel in the right parallax image may be defined as the starting point of the parallax vector, as a matter of course. In this case, the same effect can be obtained, though the sign of the parallax vector is reversed. For three or more parallax images as well, each pixel in an arbitrary image can be set as the starting point of the parallax vector.

The reference range setting unit 102 sets one or more reference ranges R within the range of depth values. The set reference range R is sent to the function setting unit 103. The reference range R can be set by various methods. For example, the user can set the reference range R using a keyboard or a remote controller (not shown). More specifically, a UI menu may be displayed on the display unit 106, to receive the entry of the setting of a reference range R by the user. Here, the reference range R may be set by the user as assigning it using the keyboard or remote controller.

The UI menu may be a menu to set the intensity of the stereoscopic effect at, for example, “low”, “middle” or “high”. Here, the user selects one of “low”, “middle” and “high” in the menu using the keyboard or remote controller, to set the reference range R as desired. Note that, for example, the reference range R may be set to be narrower when “high” is selected as compared to the case where “low” is selected.

Alternatively, the UI menu may be a “bar” in which one numerical value can be set from numerical values of a certain range (for example, 0 to 100). Here, the user selects and assigns one numerical value in the bar using the keyboard or remote controller, to set the reference range R as desired.

Meanwhile, the image processing apparatus 10 may further comprise a measurement unit (not shown) which measures the distance from the display unit 106 to the user, and thus the reference range R may be set in accordance with the distance by the reference range setting unit 102. For example, as the distance is longer, the reference range R may be set narrower. Or as the distance is shorter, the reference range R may be set wider.

As described above, the reference range R may be adjusted directly or indirectly in accordance with the user's operation.

The reference range R indicates one point or a range having a predetermined width on the depth axis z. For example, the reference range R can be set to z=0 by

R={z|z=0} (3)

Alternatively, the reference range R can be set by

$$R = \{ z \vert ( {min}_{i ∈ W} ( z ( i ) ) ) \leq z \leq 0 \} \qquad ( 4 )$$

where W is the set of the position vectors of the pixels of an entire image (one frame or a plurality of frames). In equation (4), min(z(i→))<0. In the following description, a range in the positive direction relative to the reference range R is represented by P, and a range in the negative direction relative to the reference range R is represented by Q. The above-described method of setting the reference range R is merely an example, and any other method is also usable, as a matter of course. For example, the histogram of depth values of all pixels of the image may be created, and the reference range R may be set around the depth value of highest frequency.

Using the reference range R, the function setting unit 103 sets a parallax value transform function f(z) that is a function of obtaining a transformed parallax value z′. The general form of the parallax value transform function f(z) is given by

$$f ( z ) = \{ \begin{matrix}{f}_{P} ( z ) & z ∈ P \\ z & z ∈ R \\ {f}_{q} ( z ) & z ∈ Q\end{matrix} \qquad ( 5 )$$

More specifically, the parallax value transform function f(z) performs transform not for depth values included in the reference range R but for depth values included in ranges P and Q using functions individually set for the ranges. The parallax value transform function f(z) is set not to reverse the depth relationship between an object set on the near side and an object set on the far side in the original 3D image signal. That is, the parallax value transform function f(z) is a monotone increasing function. The parallax value transform function f(z) is given by

$$f ( z ) = \{ \begin{matrix}α z + m & z ∈ P \\ z & z ∈ R \\ β z + n & z ∈ Q\end{matrix} \qquad ( 6 )$$

In equation (6), since f(z) is a monotone increasing function, α>0, and β>0. Intercepts m and n are set such that range P and range R continue, and range R and range Q continue.

FIG. 6 shows the parallax value transform function f(z) when reference range R={zᵣ|zt1≧z≧zt2}. The parallax value transform function f(z) shown in FIG. 6 is obtained by setting 0<α<1, and β>1 in equation (6). Referring to FIG. 6, the dotted line indicates z′=z. The parallax value transform function f(z) shown in FIG. 6 transforms the parallax value of a pixel having a depth value belonging to range P, that is, a pixel displayed on the far side of the display screen such that the pixel is displayed farther back. On the other hand, the parallax value transform function f(z) transforms the parallax value of a pixel having a depth value belonging to range Q, that is, a pixel displayed on the near side of the display screen such that the degree of pop-up weakens. To increase the degree of pop-up or depth, α or β of the parallax value transform function f(z) represented by equation (6) is set to be larger than 1. To weaken the degree, α or β is set to be smaller than 1. Note that in equation (6), both fₚ(z) and f_{q}(z) are linear functions. However, the present embodiment is not limited to this. Hence, fₚ(z) and f_{q}(z) can be replaced with a function other than a linear function as long as f(z) is a monotone increasing function.

A plurality of reference ranges R may be set. For two reference ranges R₁ and R₂ that do not overlap, the general form of the parallax value transform function f(z) is given by

$$f ( z ) = \{ \begin{matrix}{f}_{p} ( z ) & z ∈ P \\ z & z ∈ {R}_{1} \\ {f}_{q} ( z ) & z ∈ Q \\ z & z ∈ {R}_{2} \\ {f}_{s} ( z ) & z ∈ S\end{matrix} \qquad ( 7 )$$

Note that the parallax value transform function f(z) represented by equation (7) is also a monotone increasing function. Even when three or more reference ranges R are set, the parallax value transform function f(z) can be set in a similar manner. The parallax value transform need not always be implemented by a function operation. For example, the parallax value can be transformed using a transform table prepared in advance.

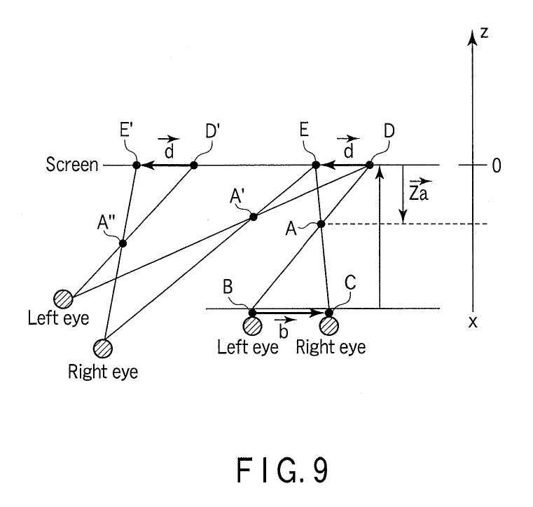

Alternatively, the parallax value transform function can be set for each of two or more regions obtained by dividing an image. For example, for a user viewing the display screen from the left-hand side, the right-hand side of the display screen is more distant in view distance as compared to the left-hand side of the display screen, and therefore the parallax value as viewed by the user becomes smaller. FIG. 9 is a view in which the eye position of the user from the left-hand side of the display screen is added to the view of FIG. 3.

For a user viewing the display screen straight from the front, with the left eye watching point D and the right eye watching point E, the user would perceive that the image projects at the position of point A. On the other hand, for a user viewing the display screen from the left direction of the display screen, the user would perceive that the image projects at the position of point A′ which is closer to the display as compared to point A. Further, the projection position for point D′ and point E′ to which a parallax value of the same parallax vector is given to the left-hand side position of the display screen is perceived at point A″, which is further from the display as compared to point A.

That is, for the same parallax value, the projection point varies depending on, for example, the angle between the user and the display screen. Thus, the parallax value transform function can be set for each of divided regions of the display screen in order to suppress this variation.

The transform unit 104 transforms the parallax value of each pixel using the parallax value transform function set by the function setting unit 103. By this transform, depth values belonging to the reference range R are maintained, whereas depth values that do not belong to the reference range R are transformed into different values. This transform does not reverse the magnitude relationship of parallax values. More specifically, when d1<d2, the transform never yields d1′>d2′.

The parallax image generation unit 105 generates a parallax image from the input images based on the parallax value of each pixel transformed by the transform unit 104, and inputs the image to the display unit 106.

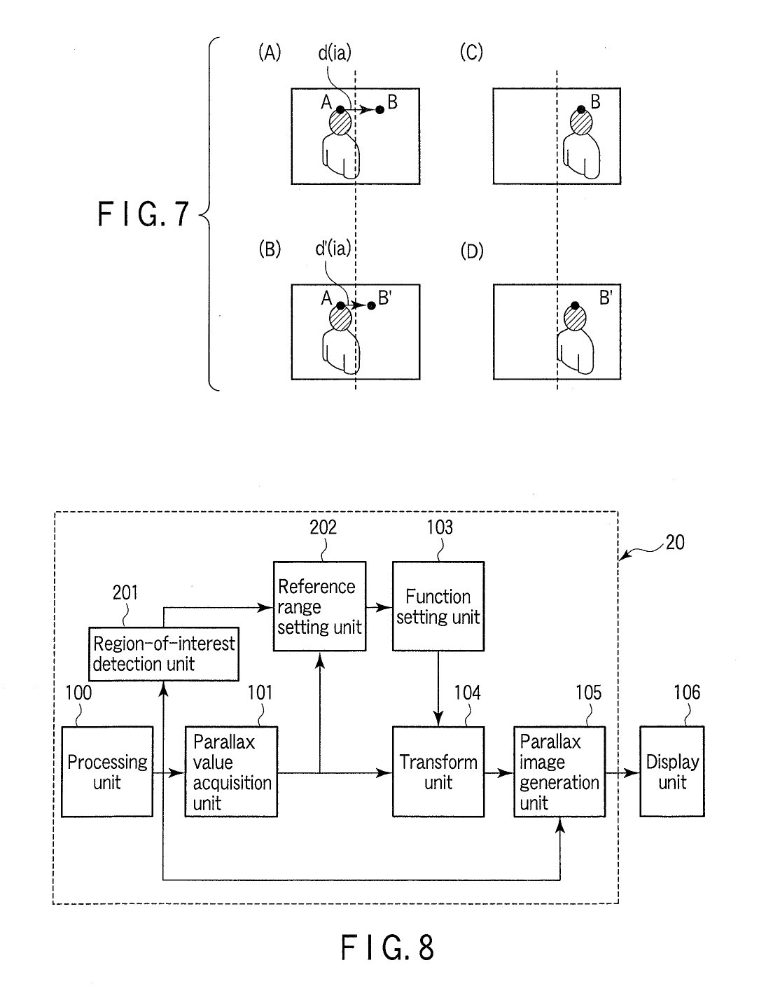

FIG. 7 is a view for explaining a parallax image generation method. Let ia→ be the position vector of the point A of the left parallax image, d(ia)→ be the parallax vector obtained by the stereo matching method, and d′(ia)→ be the parallax vector transformed by the transform unit 104 so as to decrease the parallax value. (C) in FIG. 7 shows a right parallax image based on the parallax vector d(ia)→ before transform. (D) in FIG. 7 shows a right parallax image based on the transformed parallax vector d′(ia)→.

As described above, according to the 3D display apparatus of this embodiment, it is possible to flexibly adjust the parallax so as to, for example, maintain the degree of depth and weaken the degree of pop-up. The depth positional relationship of objects defined by the original 3D image signal is maintained before and after the parallax adjustment. Hence, according to the 3D display apparatus of the embodiment, it is possible to generate a more natural 3D image signal.

### Second Embodiment

In the first embodiment, an example has been described in which the reference range R of depth values (parallax values) is arbitrarily designated. In the second embodiment, an example will be described in which a reference range R is set by detecting a specific signal from an image. For example, when an input 3D image signal includes subtitles, setting the subtitle position on the farther or nearer side changes the size of characters perceived by the user. This gives the user a sense of incongruity. Even when the parallax value of the display position of a human face changes, a sense of incongruity is given to the user due to the same reason. In this embodiment, a 3D display apparatus will be explained which detects a region (region of interest [ROI]) such as a subtitle portion or human face that attracts user's attention in an input 3D image signal, and sets a predetermined range including depth values in the region of interest as the reference range R.

FIG. 8 shows the 3D display apparatus of this embodiment. Unlike the image processing apparatus 10 in FIG. 1, an image processing apparatus 20 of this embodiment further includes a region-of-interest detection unit 201. In addition, the operation of a reference range setting unit 202 is different.

The region-of-interest detection unit 201 receives an image serving as the starting point of a parallax vector for an input image, and detect the region of interest in the image. The region-of-interest detection unit 201 inputs, to the reference range setting unit 202, one or a plurality of pixel ranges Wj (j is a natural number) that are the detected regions of interest. The method of detecting the region of interest may include acquiring, by a general telop detection method, the pixel range Wj where a telop is displayed. Note that if a plurality of telops exist, the pixel ranges are discriminated as W1, W2, . . . . The method of detecting the region of interest may include acquiring, by a general face detection method, the pixel range Wj where a human face is displayed in the image. Note that if a plurality of persons exist, the pixel ranges are discriminated as W1, W2, . . . .

The reference range setting unit 202 acquires one or a plurality of pixel ranges Wj from the region-of-interest detection unit 201, acquires the parallax vector of each pixel from a parallax value acquisition unit 101, and sets the reference range R. The set reference range R is sent to a function setting unit 103.

To set the reference range R from one pixel range W1, the reference range setting unit 202 searches for the maximum and minimum depth values in the pixel range W1, thereby setting the reference range R from the minimum value to the maximum value. That is, a reference range R1 set from the pixel range W1 is given by

$${R}_{1} = \{ {z}_{1} \vert {min}_{i ∈ {W}_{1}} ( z ( i ) ) \leq z \leq {max}_{i ∈ {W}_{1}} ( z ( i ) ) \} \qquad ( 8 )$$

If a plurality of reference ranges exist, each reference range is directly set unless they overlap each other at all. On the other hand, if some reference ranges overlap, the overlapping reference ranges are combined to set one reference range.

As described above, according to the 3D display apparatus of the second embodiment, parallax value transform is not performed for a region where deformation caused by parallax value adjustment is not preferable in a 3D image. Hence, according to the 3D display apparatus, it is possible to output a more natural 3D image signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an acquisition unit configured to acquire a parallax value of each pixel of a plurality of images having a parallax;
a setting unit configured to set at least one reference range within a range of the parallax value;
a transform unit configured to apply transform to the parallax value of each pixel so as not to change a parallax value belonging to the reference range but to change a parallax value that does not belong to the reference range without changing a magnitude relationship between the parallax values of the pixels; and
a generation unit configured to generate a parallax image from the image based on the parallax values after applying the transform.

2. The apparatus according to claim 1, further comprising a detection unit configured to detect an ROI (Region Of Interest) in the image, and
wherein the setting unit sets, as the reference range, a range of parallax values corresponding to the ROI.

3. The apparatus according to claim 2, wherein the detection unit detects, as the ROI, a region where a telop is displayed in the image.

4. The apparatus according to claim 2, wherein the detection unit detects, as the ROI, a region where a human face is displayed in the image.

5. The apparatus according to claim 2, wherein the setting unit sets the reference range including parallax value=0.

6. The apparatus according to claim 1, wherein the setting unit sets the reference range using a depth value of each pixel.

7. A 3D display apparatus comprising:
the image processing apparatus according to claim 1; and
a display unit configured to display the parallax image.

8. An image processing method comprising:
acquiring a parallax value of each pixel of a plurality of images having a parallax;
setting at least one reference range within a range of the parallax value;
applying transform to the parallax value of each pixel so as not to change a parallax value belonging to the reference range but to change a parallax value that does not belong to the reference range without changing a magnitude relationship between the parallax values of the pixels; and
generating a parallax image from the image based on the parallax values after applying the transform.
